(19) United States
(12) Patent Application Publication
(10) Pub. No.: US 2006/0227666 A1
(43) Pub. Date: Oct. 12, 2006

(54) Novelty death clock

(76) Inventor: Richard Nasef, Torrance, CA (US)

Correspondence Address: KODA & ANDROLIA, 2029 CENTURY PARK EAST, SUITE 1140, LOS ANGELES, CA, 90067, US

(21) Appl. No.: 11/103,161

(22) Filed: Apr. 11, 2005

(51) Int. Cl. G04B 19/24

(52) U.S. Cl. 368/28

(57) ABSTRACT

A novelty timepiece including a display means for displaying at least the time of day and an estimated number of years remaining until the death of the timepiece owner, a power source and a means for driving the display means powered by the power source, whereby not only is the time indicated on the display means, but also the owner of the clock can readily determine the estimated number of years remaining in the owner's life.

### BACKGROUND OF THE INVENTION

1. Field of the Invention

The present invention relates to clocks and particularly novelty clocks.

2. Prior Art

In the prior art exists several different types of clocks and timepieces. Such timepieces typically only display the time in hours, minutes, and seconds, the day of the week, and the day of the month. However, if some such clocks or timepieces have a novelty to them, it is usually in the appearance of the clock such as the clock being made in the form of a cat and with the eyes and/or tail of the cat moving back and forth in rhythm with the tick-tocking of the clock; but such novelty timepieces are limited in their novelty.

### SUMMARY OF THE INVENTION

It is a general object of the present invention to overcome the deficiencies and disadvantages of the prior art.

In particular, it is an object of the present invention to provide a novelty timepiece which indicates to the owner of the timepiece the estimated number of years until the death of the owner.

In keeping with the principles and objects of the present invention, the present invention comprises a display means for displaying at least the time of day and an estimated number of years remaining until the death of the clock owner, a power source and a means for driving the display means powered by the power source. The display means may be either analog or digital and the source of power may be a source of electricity, a spring, falling weights, manual manipulation, etc.

### BRIEF DESCRIPTION OF THE DRAWINGS

The above-mentioned features and objects of the present invention will become apparent with reference to the following description taken in conjunction with the accompanying drawings wherein like numerals denote like elements and in which:

FIG. 1 is a basic block diagram of the present invention;

FIG. 2 is an analog display used in the present invention; and

FIG. 3 is a digital display which may be used in the present invention.

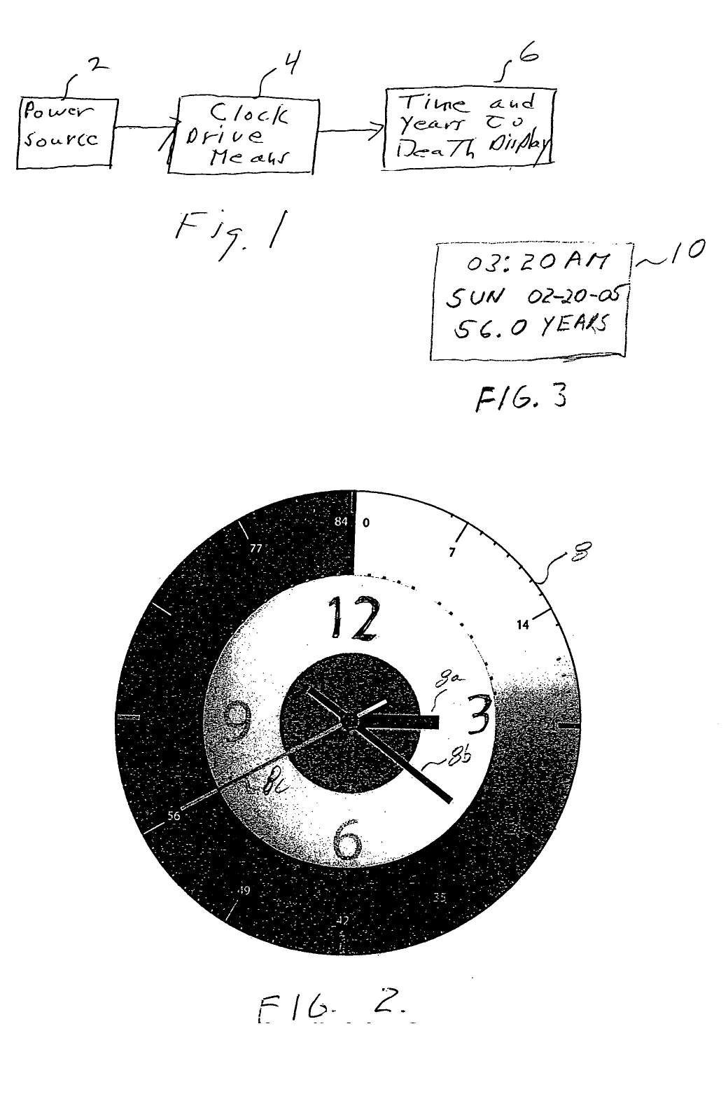

### DETAILED DESCRIPTION OF THE INVENTION

The novelty timepiece of the present invention comprises a power source 2 to supplying power to a clock drive means 4 which in turn drives a time and years to death display means 6. The power source 2 may be electrical, a spring, falling weights, etc. The clock drive means 4 could be an electrical circuit for driving a display and such electrical circuit could be easily designed or modified from an existing circuit by one of ordinary skill in the art. In addition, if the power source 2 were a mechanical source of power such a spring or falling weights, the clock drive means might be an escapement together with a plurality of gears arranged in the manner of the clockworks of a timepiece which could be easily designed by one of ordinary skill in the art.

The time and years to death display 6 can be a digital or an analog display 8 such as shown in FIG. 2. The analog display 8 could be driven by a single analog motor and gears or by a stepping motor and gears as is well known by one of ordinary skill in the art or manually manipulated by the clock owner. The analog display 8 includes an hour indicating hand 8a, a minute indicating hand 8b, and a year to death indicating hand 8c. Within the face of the analog display 8 is the provided the usual numerals for indicating the time and around the outside or circumference of the analog display 8 are the numerals 1-84, equally spaced. The numeral 84 is selected, but could be changed, since 84 years is the maximum average estimated lifespan of a human being. Accordingly, the hand 8c moves once a year to indicate the number of years attained and remaining in the life of the owner of the clock. The death hand gives a visual representation of time remaining until death on a 12 hour clock. At 42, life is half gone; at 63 it is a quarter to 12 or ¼ more to go. In addition, it should be noted that the face of the analog display 8 starts out at zero as a light color or shade and changes through darker and darker shades until it is almost or completely black as it approaches the number 84. This is to indicate visually, in addition to the numbers, the stage in life of the clock owner. This clock may or may not be so shaded.

In operation, the clock is started, and the owner moves the years to death hand 8c to the age of the user and also sets the hands 8a and 8b to indicate the time. The hands 8a and 8b will move around the analog display 8 in the same manner as in prior art timepieces and will essentially make two trips around the face in 24 hours. The hand 8c will only move once per year and will move only one increment of the 84 sections indicated on the analog display 8. In this way, the owner can always know the time and how many years he has left to live or how much life has elapsed and how much there is left.

Referring to FIG. 3, shown therein is a digital display 10, which can be utilized instead of the analog display 8. If the digital display 10 would work together with a drive means 4 which was in the form of an electric circuit and which provides signals indicative of the time, day of the week, and day of the month, together with the years until death. In other words, with the analog display, the concept is how much time (life) is remaining until 12 o'clock, i.e., at 42 it is 11:30, at 49 it is 25 to 12, at 70 it is 10 to twelve.

It should be apparent to those skilled in the art that the above-described embodiments are merely illustrative of a few of the possible embodiments which represent instruction or implementation of the present invention.

Other inventions can be readily devised by those skilled in the art without departing from the spirit of the scope of the invention. In other words, with the digital display, there is a countdown to life remaining, 56 years, 10 years, etc., to go.

1. A novelty timepiece consisting of:
an analog display means for simultaneously displaying at least a time of day and an estimated number of years remaining until death of the timepiece owner;
a power source;
a means for driving said analog display means powered by said power source.

2. (canceled)

3. (canceled)

4. The novelty timepiece according to claim 1 wherein the estimated maximum number of years until death is 84.

5. The novelty timepiece according to claim 1 wherein the estimated maximum number of years until death is a multiple of 12.

6. The novelty timepiece according to claim 5 wherein the maximum number of years until death is selected from the group consisting of 72, 84, and 96.
